(19) United States
(12) Patent Application Publication
(10) Pub. No.: US 2009/0014443 A1
(43) Pub. Date: Jan. 15, 2009

(54) CONTAINER AND SYSTEM FOR COOKING FOODS

(76) Inventor: WILLIAM A. SKAIFE, Oceanside, CA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/172,068

(22) Filed: Jul. 11, 2008

Related U.S. Application Data
(60) Provisional application No. 60/949,074, filed on Jul. 11, 2007.

(51) Int. Cl. H05B 6/80

(52) U.S. Cl. 219/734; 219/725

(57) ABSTRACT

A microwavable cooking container assembly has a bottom wall and a top rim spaced apart by a sidewalls. The container also has a notch, a gate with a steam aperture and a projection for mating within the notch. A film cover is attached to the top rim over the gate and has a fill aperture in communication with the container. The gate is moveable between a blocking position and a fill position for passing cooking ingredients through the fill aperture past the gate into the container. In another embodiment, a lid mates with the top rim and has a handle for gripping and a sealing rib for mating with the ledge seat on the top rim. The lid has a steam aperture for controllably releasing stem to create a pressure cooking environment within the container for cooking food in a microwave.

### CROSS-REFERENCE TO RELATED APPLICATIONS

This application claims priority under 35 U.S.C. § 119 of a provisional application Ser. No. 60/949,074 filed Jul. 11, 2007, which application is hereby incorporated by reference in its entirety.

The following related and commonly owned patent and patent applications are incorporated herein by reference in their entirety: U.S. Pat. No. 7,172,780 issued Feb. 6, 2007; U.S. patent application Ser. No. 10/955,186 filed Sep. 30, 2004; and U.S. patent application Ser. No. 11/800,473 filed May 4, 2007.

### BACKGROUND OF THE INVENTION

This invention relates to microwavable cooking. Specifically, this invention relates to an improved container and system for cooking foods.

It has become known that foods generally do not cook as well in a microwave as they do in an oven or stove top. Therefore, microwaves are generally only used for warming up foods and not for cooking meals.

It is known that traditional pressure cookers heat up on a stove top and create steam and pressure within the pressure cooker to decrease the cooking time of the food cooked within the pressure cooker and produce gourmet results and flavor and texture, retaining the nutrition of the food. However, pressure cookers are bulky, need maintenance, and have fallen out of favor with modern cooking trends.

In light of the foregoing, there is a need in the art for an improved container and system for cooking foods incorporating the attributes of both the pressure cooker and the microwave oven.

Thus, the primary feature or advantage of the present invention is an improved container and system for cooking foods within a microwave.

One or more of these and/or other features or advantages of the present invention will become apparent from the specification and claims that follow.

### BRIEF SUMMARY OF THE INVENTION

One or more of the foregoing features or advantages may be achieved by a microwavable pressure cooking container assembly constructed from a container body having a bottom wall and a top rim spaced apart by a substantially upright planer wall connected at opposite ends to a substantially upright convex wall. A notch extends downward from the top rim toward the bottom wall parallel to the substantially upright planer wall. A gate on the container body has a substantially planer body defined by an outer perimeter and having a steam aperture and a projection extending away from the substantially planer body for inserting within the notch. A film cover is attached to the top rim over the gate and has a fill aperture in communication with the container body. The gate is movable between a blocking position and covering relation to the fill aperture and a fill position for passing cooking ingredients through the fill aperture, past the gate into the container body.

A further aspect of the present invention is a microwavable cooking container assembly having a recess in the substantially upright planer wall extending from the bottom wall to the top rim for nesting and stacking one container within another.

A further aspect of the present invention is a microwavable cooking container assembly having one or more channels in the bottom wall for channeling steam from an underlying stacked microwavable cooking container assembly and suspending cooking ingredients above the bottom wall.

A further aspect of the present invention involves a microwavable cooking container assembly having a detent within the notch that mates with a keeper notch on the projection for keeping the projection within the notch and urging the gate from the fill position to the blocking position.

A further aspect of the present invention involves a microwavable cooking container assembly wherein the gate in the blocking position prevents steam from escaping the container body through the fill aperture.

A further aspect of the present invention involves a microwavable cooking container assembly wherein steam from the container body is controllably released through the steam aperture to thereby create a pressure cooking environment for cooking ingredients within the container body.

A further aspect of the present invention involves a microwavable cooking container assembly wherein the gate has a reinforcement rib running along the outer perimeter of the substantially planer body to strengthen the substantially planer body against failure and to bias the gate toward the blocking position.

A further aspect of the present invention involves a microwavable cooking container assembly wherein the container body is half-moon shaped to thereby facilitate positioning the substantially upright planer walls of two containers adjacent each other to best use space within a microwave.

One or more of the foregoing features and/or advantages may additionally be achieved by a method for cooking one or more foods in a microwavable cooking container assembly within a microwave by taking the microwavable cooking container assembly having a container body with a bottom wall and a top rim spaced apart by side walls, a gate attached to the top rim and a film cover attached to the top rim over the gate and having a fill aperture in communication with the container body, flexing the gate open away from the film cover, inserting ingredients through the fill aperture past the gate into the container body, placing the container body within the microwave, heating ingredients within the container body, releasing steam from a steam aperture in the gate, and controlling the rate of cooking using the steam in the container body and energy from the microwave.

A further aspect of the present invention involves the step of urging the gate to a closed position and covering relation over the fill aperture using reflex behavior in the gate.

A further aspect of the present invention involves the step of sealing one or more foods within the container body for resale.

A further aspect of the present invention involves removing the seal for adding additional ingredients through the fill aperture to prepackage foods within the container body.

A further aspect of the present invention involves corrugating the bottom wall with steam channels for channeling steam from one or more underlying microwavable cooking container assemblies and suspending food above the bottom wall.

A further aspect of the present invention involves shaping the container body in a half-moon shape for placing two containers back-to-back within the microwave.

One or more of the foregoing features and/or advantages may additionally be achieved by a system for cooking one or more foods separate from each other at the same time in the same container. The system has one or more microwavable containers nested inside each other within a base container and a lid having a steam aperture and a handle for gripping. The lid is adapted to sealingly engage and cover each of the microwavable containers and the base container. A sleeve having an inside cover and an outside cover houses and keeps the microwavable containers together for resale and storage. One or more recipe software are printed on the inside cover of the sleeve for describing operation of the system.

A further aspect of the present invention involves a system wherein the outside cover has advertising indicia to promote and sell the system.

A further aspect of the present invention involves a system where a user follows the recipe software to cook food separate from each other at the same time in one or more of the microwavable containers within the base container so that each food is fully cooked at the same time thereby providing a complete meal.

### BRIEF DESCRIPTION OF THE DRAWINGS

FIG. 1 is an isometric view of one embodiment of the microwavable cooking container assembly according to an exemplary embodiment of the present invention.

FIG. 2 is a plan view of the microwavable cooking container assembly shown in FIG. 1.

FIG. 3 is a side view of the microwavable cooking container assembly shown in FIG. 1.

FIG. 4 is an isometric view of the gate of the microwavable cooking container assembly according to an exemplary embodiment of the present invention.

FIG. 5 is an isometric view of another embodiment of the microwavable cooking container assembly with a lid according to an exemplary embodiment of the present invention.

FIG. 6 is a plan view of the microwavable cooking container assembly shown in FIG. 5.

FIG. 7 is a side view of the lid of the microwavable cooking container assembly shown in FIG. 5.

FIG. 8 is a front side view of the lid of the microwavable cooking container assembly shown in FIG. 5.

FIG. 9 is a sectional view of the microwavable cooking container assembly taken along line A-A in FIG. 5.

FIG. 10 is an isometric view of the microwavable cooking container assembly and lid according to an exemplary embodiment of the present invention.

FIG. 11A is another embodiment of the microwavable cooking container assembly according to an exemplary embodiment of the present invention.

FIG. 11B is another embodiment of the microwavable cooking container assembly according to an exemplary embodiment of the present invention.

FIG. 11C is another embodiment of the microwavable cooking container assembly according to an exemplary embodiment of the present invention.

FIG. 12 is a side elevation view of the microwavable cooking container assemblies partially nested within each other and having a lid according to an exemplary embodiment of the present invention.

FIG. 13 is an isometric view of the microwavable cooking container assemblies nested within each other and having a lid according to an exemplary embodiment of the present invention.

FIG. 14 is an isometric view of the microwavable cooking container assembly and gate according to an exemplary embodiment of the present invention.

FIG. 15 is a photograph showing the microwavable cooking container assembly stacked together within a microwave.

FIG. 16 is a photograph of two microwavable cooking container assemblies stacked on top of each other and illustrates the course of travel for steam exiting the bottom container assembly and through the steam channel in the top container assembly according to an exemplary embodiment of the present invention.

FIG. 17 is another embodiment of the microwavable cooking container assembly according to an exemplary embodiment of the present invention.

FIG. 18 is a front elevation view of the microwavable cooking container assembly shown in FIG. 17.

FIG. 19 is a front elevation view of another embodiment of the microwavable cooking container assembly according to an exemplary embodiment of the present invention.

FIG. 20 is a side elevation view of another embodiment of a microwavable cooking container assembly according to an exemplary embodiment of the present invention.

FIG. 21 is a plan view of the microwavable cooking container assembly shown in FIG. 20.

FIG. 22 is a plan view of the microwavable cooking container assembly shown in FIG. 20 without the lid.

FIG. 23 is a software recipe according to an exemplary embodiment of the present invention.

FIG. 24 is another software recipe according to an exemplary embodiment of the present invention.

### DETAILED DESCRIPTION OF THE PREFERRED EMBODIMENT

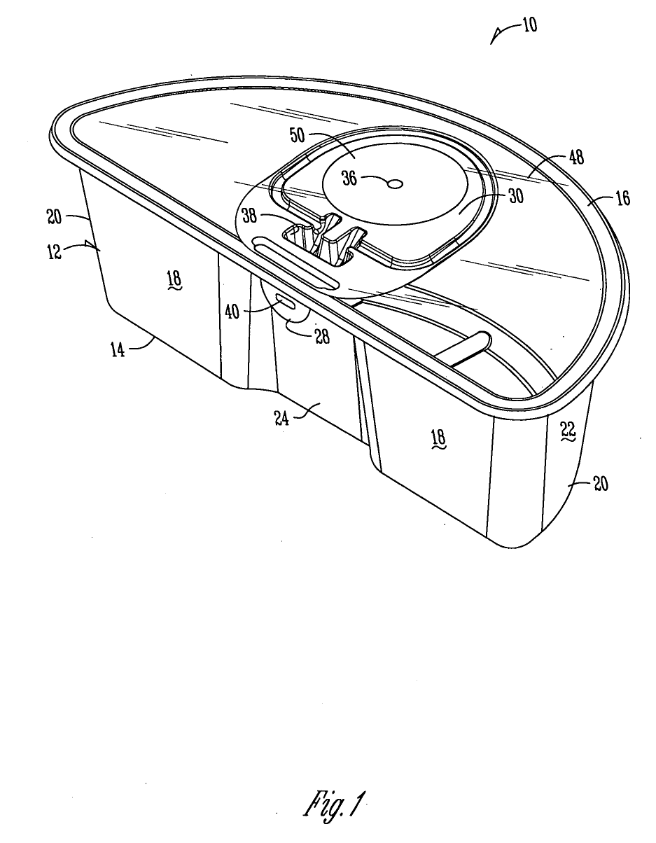

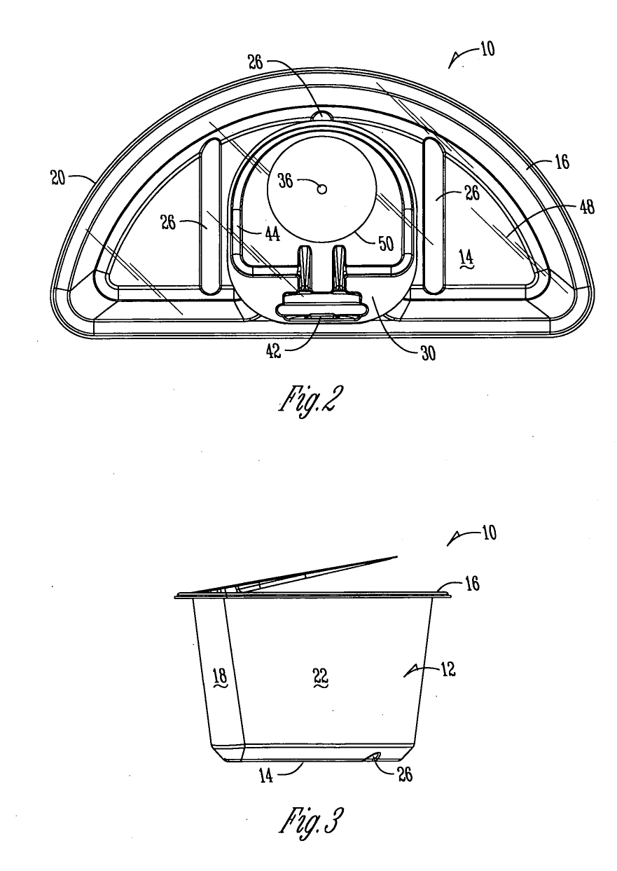

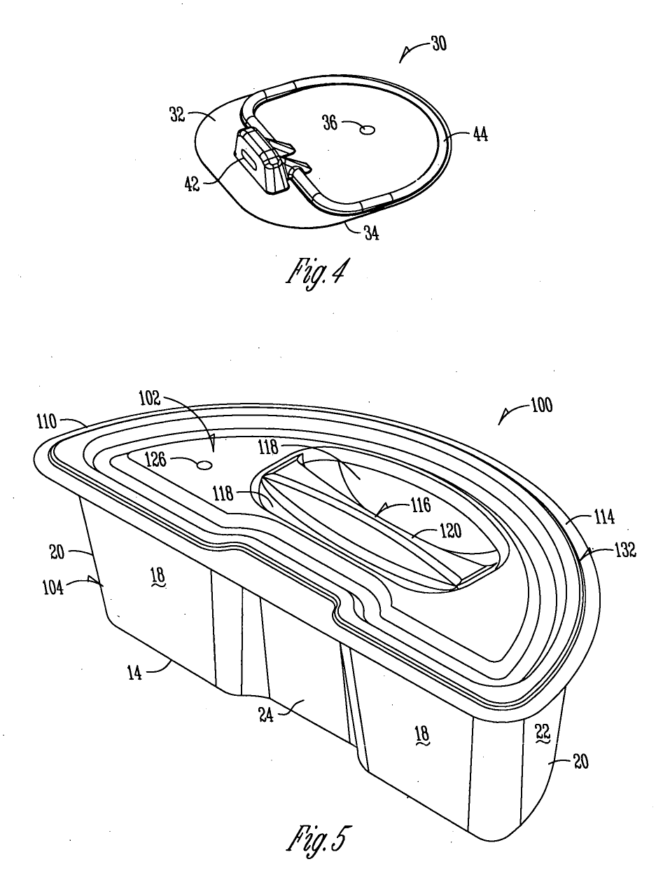

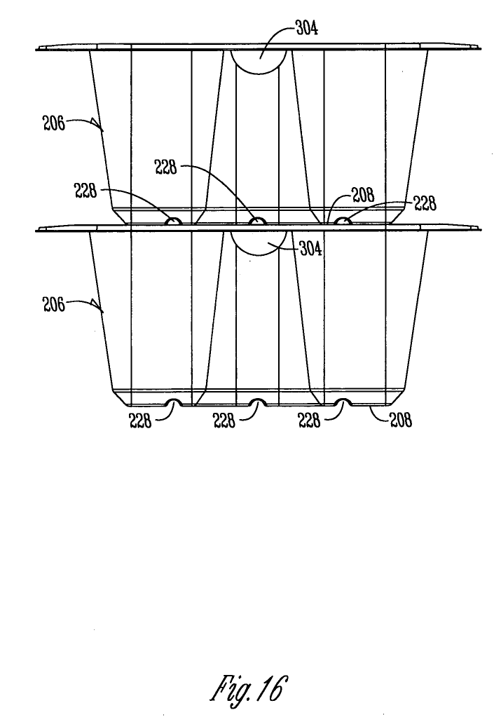

FIG. 1-4 show a preferred embodiment of one of the microwavable cooking container assemblies of the present invention. The microwavable cooking container assembly 10 is preferably constructed of a material capable of withstanding temperatures necessary for cooking and resulting from water changing from liquid form to the steam form within the container for cooking ingredients within the container. The microwavable cooking container assembly 10 has a container body 12 that is defined by a bottom wall 14 and a top rim 16. The bottom wall 14 and top rim 16 are spaced apart by a substantially upright planer wall 18. The substantially upright planer wall 18 is connected at opposite ends to a substantially upright convex wall 22. In a preferred embodiment, the container body 12 is half-moon shaped to thereby facilitate positioning two container bodies back to back beside each other within the microwave. However, it can be appreciated by those skilled in the art that the container body 12 could take on many different shapes so as to match the use of space within a microwave 56 (as shown in FIG. 15) for cooking with the microwavable cooking container assembly 10.

To facilitate nesting and stacking one container body 12 within another, a recess 24 is formed in the substantially upright planer wall 18 and extends from the bottom wall 14 to the top rim 16 of the container body 12. Also, configured into the bottom wall 14 of the container body 12 are one or more steam channels 26. These channels 26 help in moving steam from an underlying container body 12 out from under and away from the overlying container body 12 when the containers are stacked one on top of the other. The channels 26 also facilitate suspending cooking ingredients above the bottom wall 14 within the container body 12 for cooking purposes, such as for allowing grease to drip off of the food and away from the bottom wall 12 to thereby separate the oil and drippings from the food suspended on the channels 26 within the container body 12.

Positioned on the top rim 16 of the container body 12 is a notch 28 that extends downward from the top rim 16 toward the bottom wall 14 and parallel to the substantially upright planer wall 18. The notch 28 may be formed as a square, semi-circle circular, oval or otherwise. The notch 28 may be formed within the substantially upright planer wall 18 or a separate piece formed in the top rim 16 that extends downward parallel to the substantially planer wall 18.

Removably attached near the top rim 16 of the container body 12 is a gate 30 that is defined by a substantially planer body 32 having an outer perimeter 34 and a steam aperture 36 that passes through the substantially planer body 32. The gate 30 also has a projection 38 that extends away from the substantially planer body 32 and takes on the shape of the notch 28. The projection 38 is shaped to mate with the notch 28 by fitting inside the notch 28. A detent 40 within the notch 28 mates with a keeper notch 42 on the projection 38 for keeping the projection 38 within the notch 28. The gate 30 also has a reinforcement rib 44 running along the outer perimeter 46 of the substantially planer body 32 to strengthen the body against failure. Connected to the top rim 16 above the gate 30 is a film cover 48. The film cover 48 has a fill aperture 50 that is in communication with the container body 12. The gate 30 is movable between a blocking position and a fill position. In the blocking position the gate 30 is biased against the film cover 48 and covers the fill aperture 50 so as to block communication through the fill aperture 50 into the container body 12. By depressing the gate 30 and moving the gate 30 downward to a fill position, food items and ingredients can be inserted through the fill aperture 50 past the gate 30 into the container body 12. To ensure that the gate 30 remains in the blocking position, beside from times when the gate 30 is physically moved downward by the user, a reflex behavior is implemented into the gate 30, whereby the gate 30 is continually biased toward the blocking position in relation to the fill aperture 50. By reflex behavior it is meant that the gate 30 may be bent downward away from the blocking position to the fill position, but is continually urged toward the blocking position by the notch 28 supportingly engaging the projection 38 which may resistively flex outward away from the substantially upright planer wall 18 to urge the gate 30 from the fill position back to the blocking position in covering relation over the fill aperture 50. In the blocking position, the gate 30 prevents steam from escaping from the container body through the fill aperture 50. Thus, steam from the container body 12 is controllably released through only the steam aperture 36 to thereby create a pressure cooking environment for cooking ingredients within the container body 12.

It should be appreciated by those skilled in the art that the container body may have prepackaged foods, ingredients added to the prepackaged food within the container body 12 and/or ingredients added into the empty container body 12 for cooking. For example, a roast may be prepackaged within the container body 12 and wrapped with a food safe heat shrink cover and positioned within the meat department for resale. Upon purchase, additional ingredients such as carrots, potatoes, water, and seasonings may be added through the fill aperture 50 past the gate 30 and into the container body 12 with the roast for cooking within the microwave 56. In addition to the reflex behavior built into the gate 30 and the way in which gate 30 is attached to the container body 12, steam pressure within the container body 12 also urges the gate 30 from the fill position toward the blocking position in covering relation to the fill aperture 50 in the film cover 48 such that the substantially planer body 32 of the gate 30 mates with the film cover 43 so that steam is controllably released from the container body 12 through only the steam aperture 36 to create a pressure cooking environment for cooking ingredients within the container body 12.

The present invention contemplates various uses, operations, configuration alternatives and cooking methods/processes for the microwavable cooking container assembly shown in FIGS. 1-4. For example, the present invention contemplates various cooking opportunities such as where vegetables may be prepackaged within the container body 12 or inserted through the fill aperture 50 past the gate 30 into the container body 12. The steam aperture positioned through the gate 30 controllably releases steam from the container body 12 to thereby create a pressure cooking environment within the container body 12 for cooking the food within the container body 12, such as potatoes, carrots, onions or other ingredients. The gate is moved from the blocking position in covering relation over the fill aperture 50 in the film cover 48 to a fill position whereby food and ingredients may be inserted into the container body 12 past the gate 30. It should be appreciated that two or more of the container bodies 12 could be stacked back to back within the microwave or in a stand alone position as shown in FIG. 33. In stacked formation, steam channels 26 positioned in the bottom wall 14 of each of the container bodies 12 helps to channel steam away from the underlying container body 12 past the overlaying container body 12. Thus, four container bodies may be stacked back to back and on top of each other for cooking an entire meal within the microwave oven. During cooking, energy from the microwave 56 is transferred into the food and/or ingredients inserted in the container body 12 or prepackaged within the container body 12 thereby releasing steam which is prevented from escaping from the container body 12 except through the steam aperture 36 in the gate 30 for cooking food within the container body 12 using the pressure and steam similar to how a commercially available pressure cooker operates.

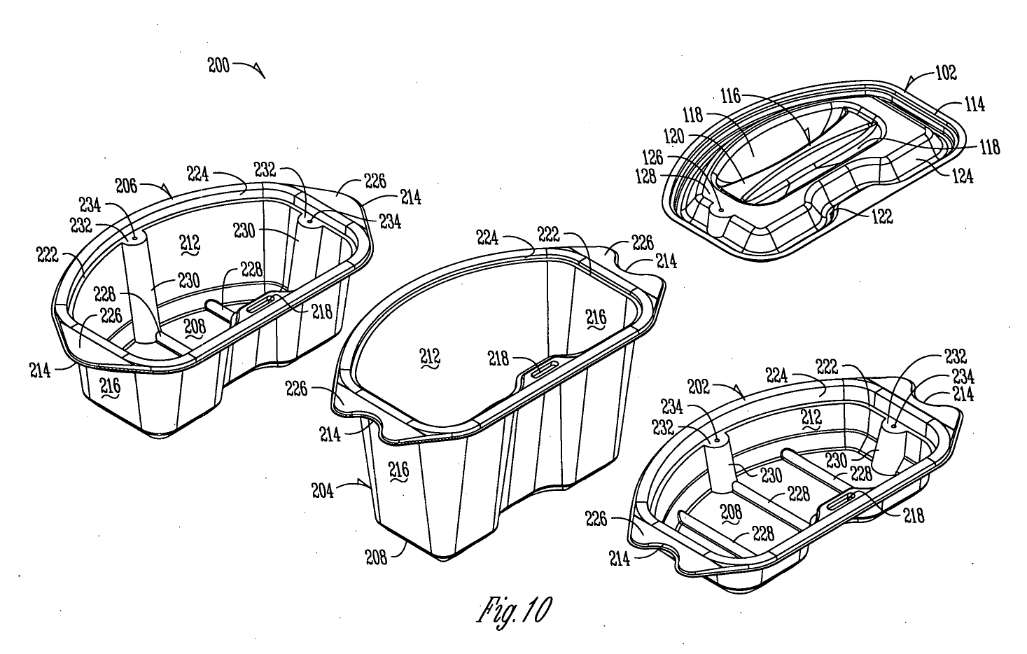

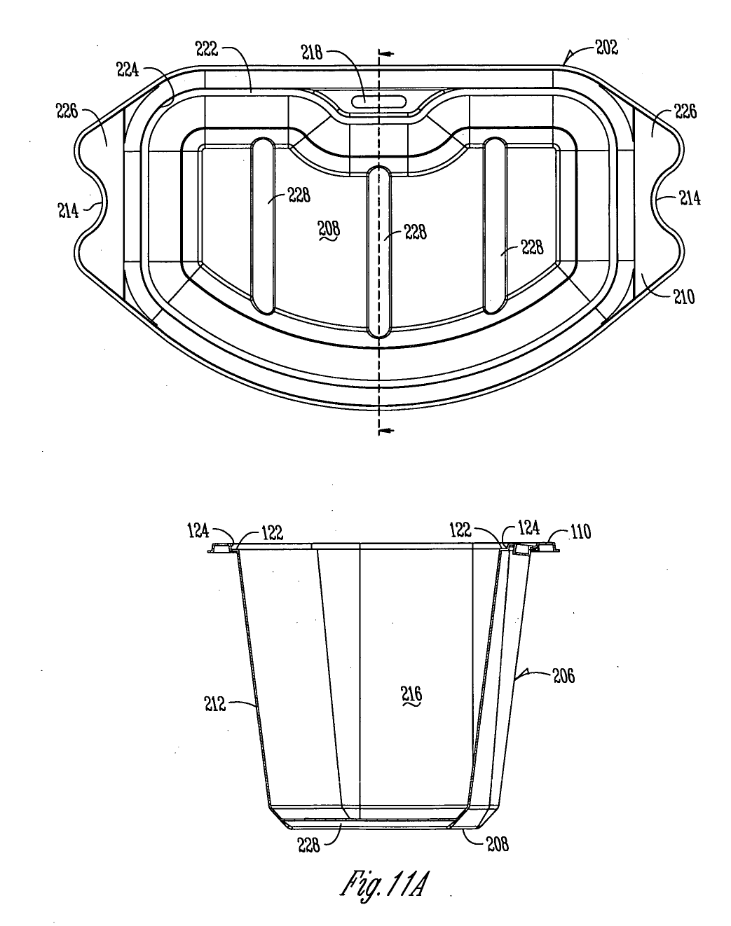

In another embodiment of the microwavable cooking container assembly 100, a lid 102 is positioned atop the container body 104 for retaining steam within the container body 104 as shown in FIGS. 5-9. In this particular embodiment, the film cover 43 and gate 30 (shown in FIGS. 1-4) are replaced by the lid 102. The lid 102 is adapted to nest within and mate to the top rim 110 of the container body 104. Thus, the microwavable cooking container assembly 100 shown in FIGS. 1-4 may be used with the lid 102 after the film cover 43 is removed.

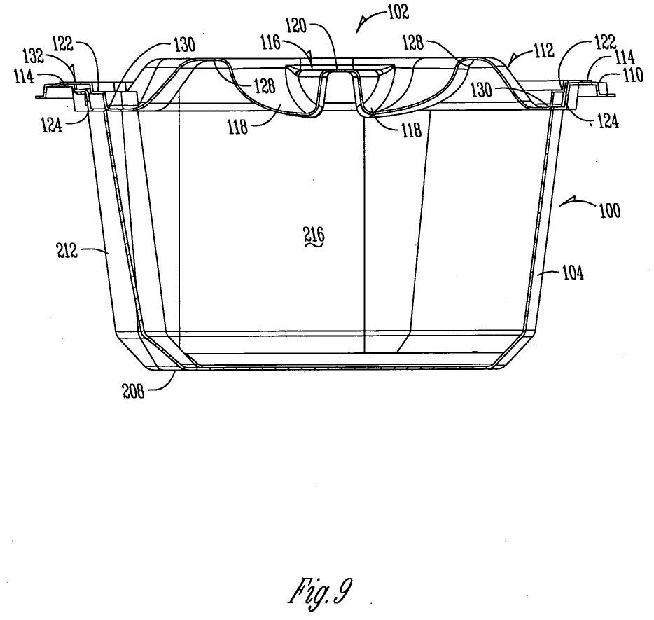

FIGS. 6-8 best illustrate the lid 102. The lid 102 is defined by a lid body 112 having a planer outer perimeter 114 for mating with the top rim 110 of a container body 104. A handle 116 is formed toward the middle of the lid body 112 between oppositely spaced recesses 118 to provide a raised portion 120 for gripping. A positioning rib 122 runs adjacent along the planer outer perimeter 114 of the lid body 112 and is shaped to mate with the inner perimeter 124 along the top rim 110. In addition to controlling positioning of the lid 102 onto the container body 104, the positioning rib 122 formed of a downwardly extending flange 134, seals against the adjacent inner side walls 136 of the upper portion 138 of the container body 104. There are no latches, clasps or snaps that secure the lid 102 to the container body 104. The lid 102 of the present invention does not create an air tight storage environment within the container body 104 as the lid 102 does not secure or clamp to the outer circumference of a top rim 110 of the container body 104, such as is prevalent with many air tight storage bowls or containers that would not be suitable for microwave cooking. Containers or bowls having lids that snap, clasp or latch to the container/bowl would be inherently dangerous as microwavable cooking containers because the user would be forced to handle the hot container/bowl and even manipulate a hot latch, clasp or snap to remove the lid, which would invariably expose the user's hands to hot surfaces and dangerous escaping steam when attempting to remove the lid for storing or checking the food within the container/bowl. Because these containers are not for microwave cooking, they are not designed with handles that allow the user to safely remove and reattach the lid when checking or stirring the food within the container/bowl. As such, the lid 102 of the present invention was designed to fit snugly between the positioning/sealing rib 122 and 130 (rest inside the rim of the container body 104), which facilitates steam retention within the container body 104 and permits the lid 102 to be easily removed and replaced. This is critical as the user may easily and safely remove the lid 102 to stir or check the food within the container body 104 for doneness without being exposed to hot escaping steam. A steam aperture 126 is positioned through the lid body 112 a safe distance from the raised portion 120 of the handle 116 for controllably releasing steam from the container body 104 to thereby create a pressure cooking environment for cooking ingredients within the container body 104 when the lid 102 is positioned on top of the container body 104. The steam aperture 126 has a fixed diameter to let out a calculated amount of steam so the space within the container body 104 becomes a calculated pressure cooking environment. The steam aperture 126 is of a fixed diameter or in other words is not adjustable so the cooking accuracy of the container is maintained. For example, variable steam apertures, without specific instructions for use, would not provide an accurate steam pressure cooking environment. The user would be left to guess the amount of cooking time, desired power requirement and proper diameter of the steam aperture, which would lead to a trial and error method of microwave cooking instead of precision cooking offered by the present invention. A recessed channel 128 is formed within the lid body 112 for directing steam through the recessed channel 128 toward the steam aperture 126 within the lid body 112. The handle 116 is raised from the body 112 of the lid 102 to provide a structure/surface away from the recessed channel 128 (containing steam) and the steam aperture 126 (releasing steam from the container body 104) for gripping. Due to the design, position and ease of removal of the lid 102 from the container body 104, the user is able to grip the handle 116, remove the lid 102, check and stir the contents within the container body 104, and reapply the lid 102 without risking exposure to his/her hands to dangerously hot escaping steam. The recessed channel 128 within the lid body 112 is best illustrated in the sectional view shown in FIG. 9. FIG. 9 also best illustrates how the positioning rib 122 mates with the inner perimeter 124 of the top rim 113 of the container body 104 to seal steam within the container body 104. One of ordinary skill in the art could appreciate that the positioning/sealing rib 122 and 130 could be elongated to provide a deeper sealing face between the inner, top side wall 136 of the container body 104 and the positioning/sealing rib 122 and 130. A deeper positioning/sealing rib 122 and 130 could be adjusted to comport with changes in the design of the steam aperture 126 or the amount of steam and pressure desired in the container body 104 for cooking. For example, if a greater steam content or pressure is desired in the container body 104, the depth of the positioning/sealing rib 122 and 130 could be altered, elongated or shorted to create a more secure, safe and accurate cooking environment. By way of example, if the steam aperture 126 were decreased in diameter, the pressure and steam content within the container body 104 would increase. The increased pressure and steam would create an upper force on the lid 102. The positioning/sealing rib 122 and 130 could be designed with a greater depth to provide a greater contacting area between the inner, top side wall 136 of the container body 104 and the positioning/sealing rib 122 and 130, which would create more friction between the lid 102 and container body 104 to resist the increased upward forces thereby maintaining the desired pressure cooking environment within the container body 104. Failing to consider the specific required amount of contacting surface between the lid 102 and the container body 104 could result in the lid 102 unknowingly or undesirably being lifted from and/or becoming misaligned with the container body 104 resulting in steam/pressure loss.

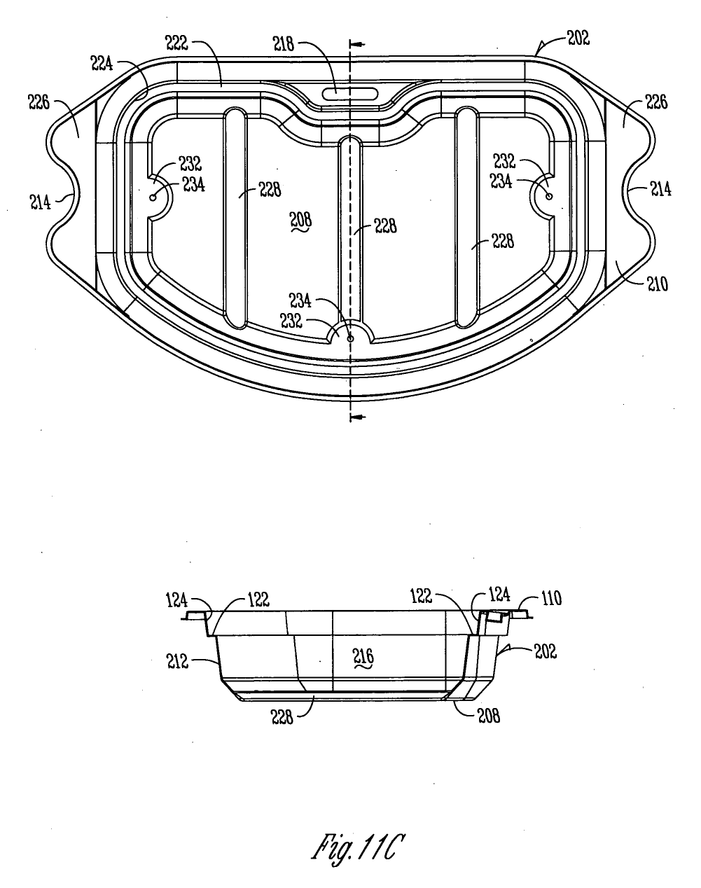

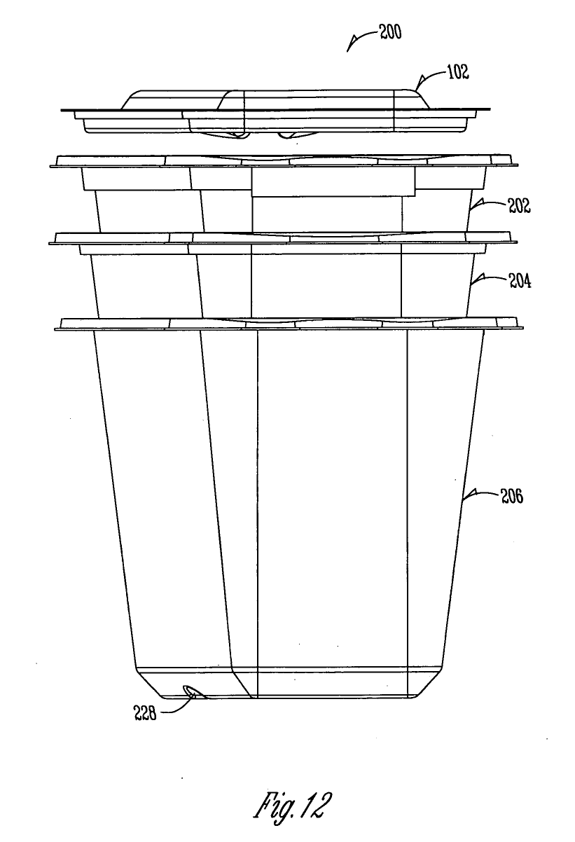

FIGS. 11A-11C show another embodiment of the microwavable cooking container assembly 200. FIGS. 11A-11C show the different size container bodies 202, 204 and 206 adapted to nest inside one another or be used in stand alone operation. Each of the container bodies 202, 204 and 206 shown in FIGS. 11A-11C are defined by a bottom wall 208 and a top rim 210 spaced apart by a substantially upright planer wall 212 connected on opposite ends 214 to a substantially upright convex wall 216. Each container body 202, 204 and 206 are fashioned in a half-moon shape but may also be shaped otherwise, such as a “D” shape, pie shape and/or semi-oval shape. A recess 215 is fashioned in the substantially upright planer wall 212 for nesting and stacking one container within another. Extending downward from the top rim 210 toward the bottom wall 208 and parallel with the substantially upright planer wall 212 is a notch 220. The top rim 210 also has a ledge seat 222 running along the inside perimeter 224 providing a transition from the top rim 210 into the container body 202. A pair of handles 226 are fashioned on opposite ends 214 of the top rim 210 of the container bodies 202, 204 and 206 for gripping as best shown in FIGS. 11A-11C. The handles 226 on each container body 202, 204 and 206 are fashioned so that each container body 202, 204 and 206 may be gripped and separated from the other when the container bodies 202, 204 and 206 are nested together. Fashioned within the bottom wall 208 of each container body 202, 204 and 206 are one or more steam channels 228 extending between the substantially upright planer wall 212 and the substantially upright convex wall 216 on the bottom wall 208. The smaller container bodies 202 and 204 shown in FIGS. 11B and 11C have semi-conical recesses 230 fashioned into the substantially upright convex wall 216. These semi-conical recesses 230 extend from the bottom wall 208 and terminate adjacent the top rim 210 in a planer surface 232 that is parallel with the top rim 210 and has a steam aperture 234 there through. The semi-conical recesses 230 taper from a larger bore to a smaller bore as they extend from the bottom wall 208 toward the top rim 210. At least one of the semi-conical recesses 230 is in communication with the steam channel 228 positioned on the bottom wall 208 of each container 202, 204 and 206.

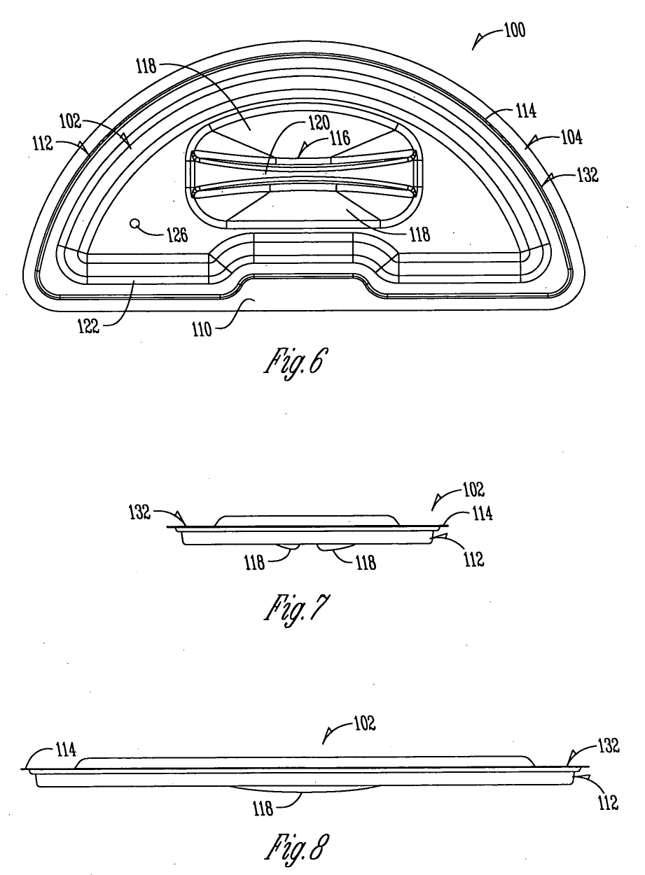

The lid 102 shown in FIGS. 6-8 is adapted to nest atop each of the container bodies 202, 204 and 206 shown in FIGS. 11A-11C. As previously described, the lid 102 has a positioning rib 122 running along the outer perimeter 114 of the lid body 112. The positioning rib 122 helps to seat the lid body 112 properly atop each container body 102, 104 and 43. A sealing rib 130 runs along the outer perimeter 114 of the lid body 112 adjacent the positioning rib 122. The sealing rib 130 mates with the ledge seat 222 running along the inside perimeter 224 of the top rim 210 of each container body 202, 204 and 206. The outer most portion 132 of the lid body 112 is defined by a planer outer perimeter 114. When the lid 102 is seated within the top rim 210 of each container body 202, 204 and 206, the planer outer perimeter 114 of the lid 102 mates with the top rim 210 of each container body 202, 204 and 206 and working in conjunction with the sealing rib 130 seals the lid 102 to the container body 202, 204 and 206 to prevent steam from passing out of the container body 202, 204 and 206 except through the steam aperture 126. Also, as previously described, a gate 30 as shown in FIG. 4 may be used with each of the container bodies 202, 204 and 206 shown in FIGS. 11A-11C by inserting the projection 38 on the gate 30 into the notch 220 on the top rim 210. Each of the container bodies 202, 204 and 206 when using the gate 30 may be covered with a film cover 48 having a fill aperture 50 for covering the gate 30 and the mouth of each container body 202, 204 and 206.

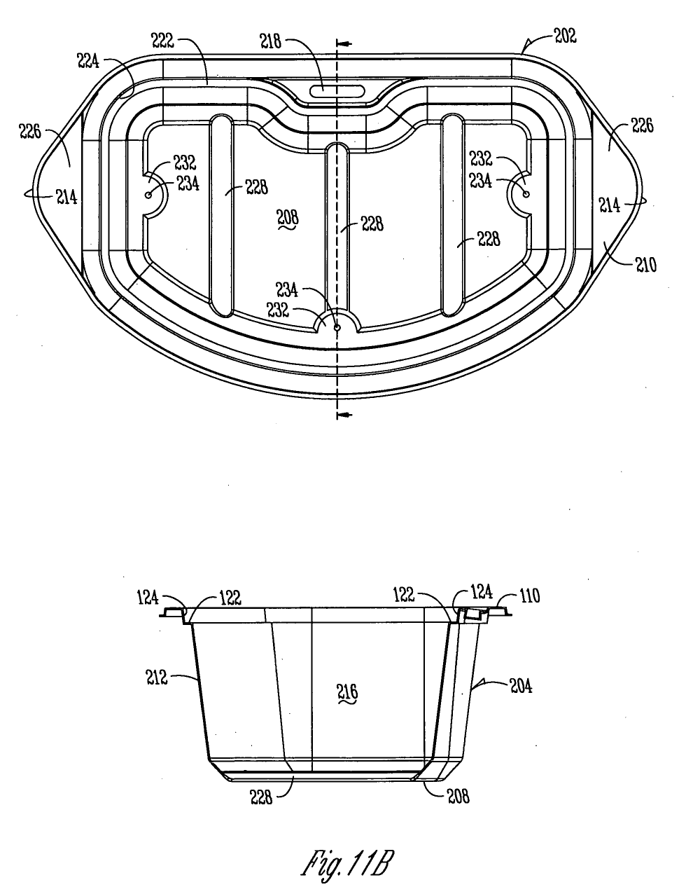

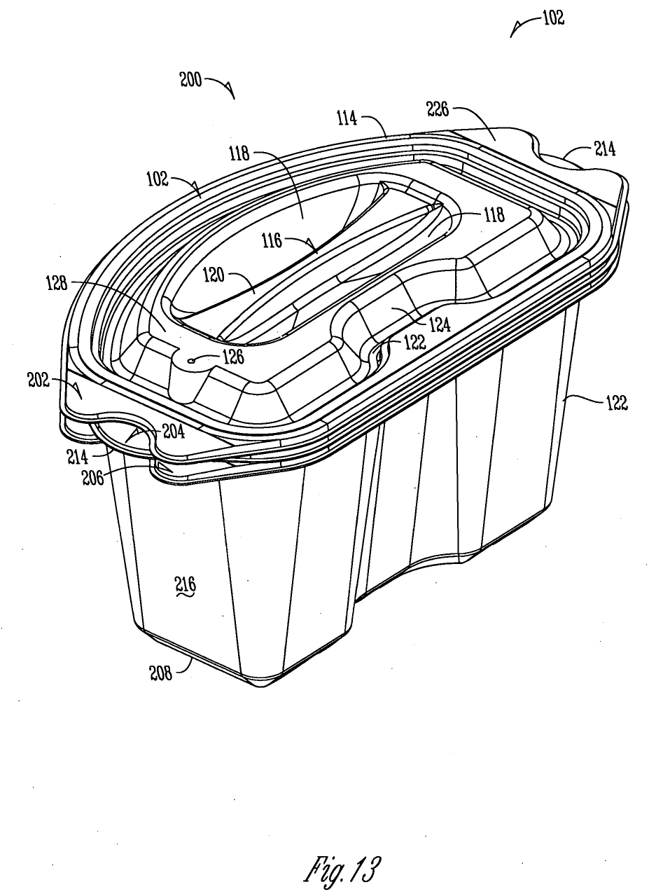

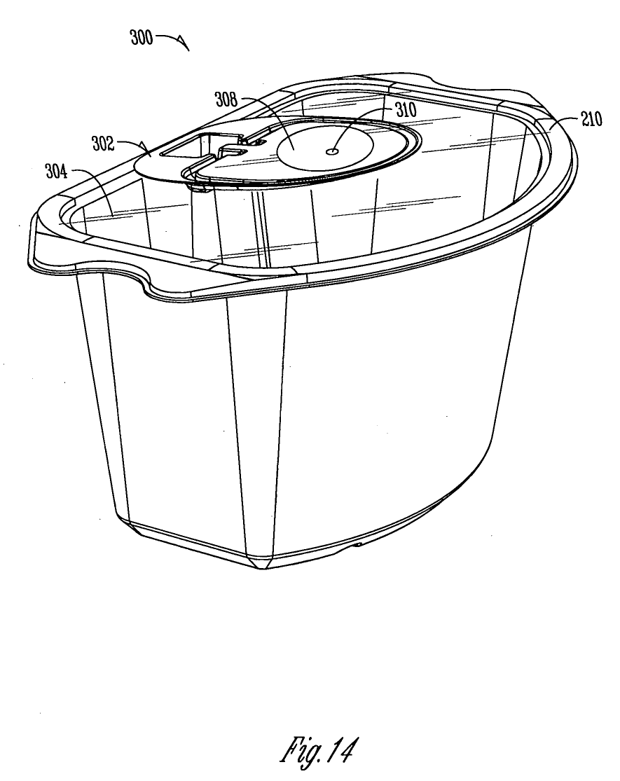

The progressively sized container bodies 202, 204 and 206 shown in FIGS. 11A-11C are designed to nest within the other from the smallest to the largest. Thus, the container body 202 shown in FIG. 10C nests inside the container body 204 shown in FIG. 11B which in turn nests inside the container body 206 shown in FIG. 11A, as shown in FIGS. 10, 12 and 13. FIG. 12 best illustrates the nesting capability of each of the container bodies 202, 204 and 206. Thus, the top rim 210 of the container body 204 shown in FIG. 11B is fashioned so that it mates with the top rim 210 of the container body 206 shown in FIG. 11A when the container body 204 shown FIG. 11B is nested inside the container body 202 shown in FIG. 11C. Similarly, the top rim 210 of the container body 202 shown in FIG. 11C is fashioned to mate with the top rim 210 of the container body 204 shown in FIG. 11B when the container body 202 in FIG. 11C is nested inside the container body 204 shown in FIG. 11B. The mating of the top rim 210 of the container body 202 shown in FIG. 11C with the top rim 210 of container body 204 shown in FIG. 11B and with the top rim 210 of the container body 206 shown in FIG. 11A helps to keep steam from escaping out of each of the container bodies 202, 204 and 206 except through steam aperture 234 in the semi-conical recesses 230 in the substantially upright convex wall 216 of each of the nested container bodies 202, 204 and 206. In this manner, steam generated in the bottom or base container body 206 (shown in FIG. 11A) or middle nested container body 204 (shown in FIG. 11B) is passed into one or more of the overlying container bodies through the steam aperture 234 in each of the semi-conical recesses 230. It should be appreciated that each of the container bodies 202, 204 and 206 may be used as a stand alone microwavable cooking container assembly using the lid 102 or nested together as one microwavable cooking container assembly. Furthermore, one or both of the container bodies 202 and 204 shown in FIGS. 11B and 11C could be nested within the container body 206 shown in FIG. 11A and topped with the lid 102 to provide the microwavable cooking container assembly 200. In either case, whether one or both of the container bodies 202 and 204 shown in FIG. 11B or 11C is nested within the container body 206 shown in FIG. 11A, steam generated within the container bodies 202, 204 and 206 is passed from an underlying container body into an overlying container body through steam apertures 234 within the semi-conical recesses 230 and controllably released through a steam aperture 126 in the lid 102 to thereby create a pressure cooking environment for cooking ingredients within the microwavable cooking container assembly 200.

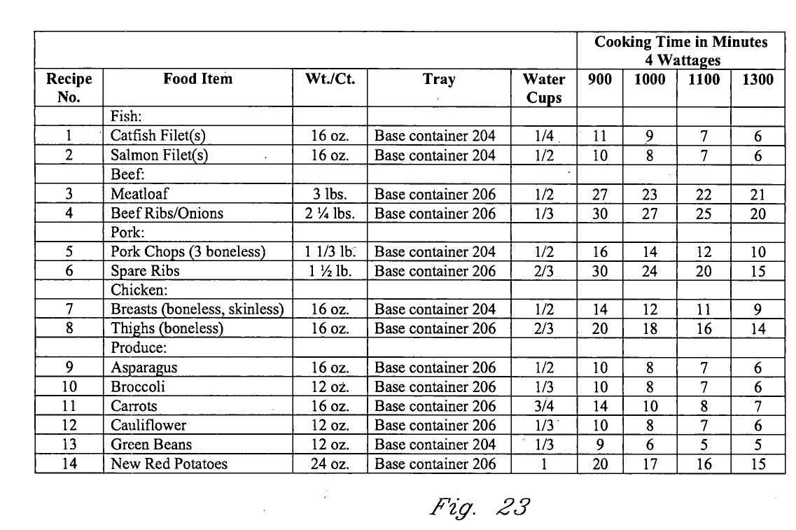

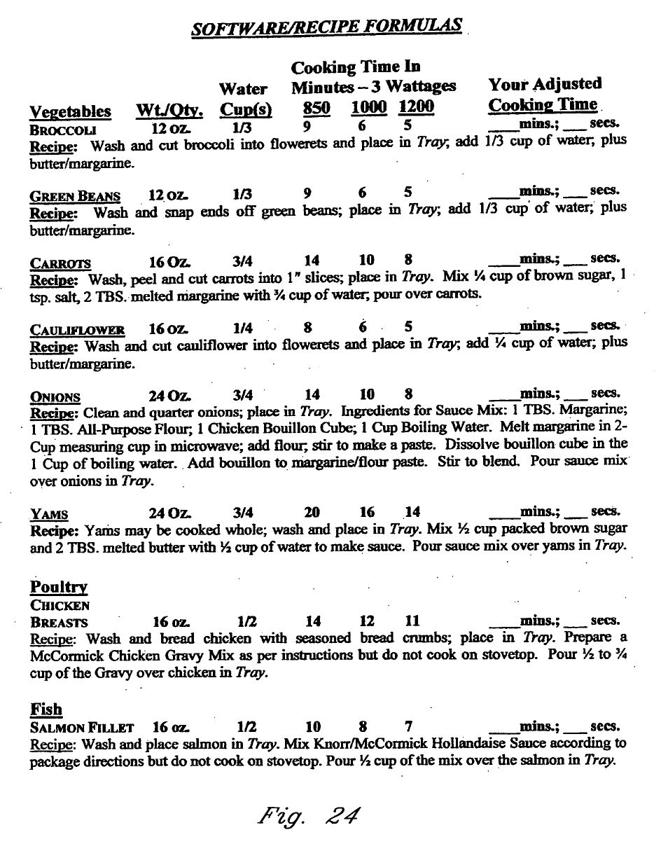

The present embodiments of the microwavable cooking container assembly 10, 100 and 200 configured in the half-moon shape helps facilitate maximum use of the space and capabilities of the microwave oven 56 for fast, accurate cooking. Using the embodiments of the present invention, a single meal may be prepared from recipe software, such as those illustrated in FIGS. 23 and 24, using one or more or all of the container bodies 12, 104, 202, 204 and 206 heated within the microwave 56. For example, two container bodies could be stacked on top of another and positioned back to back within the microwave oven 56. The bottom container body may be used having the lid 102 or the film cover 48 with the gate 30 designed to close the fill aperture 50 within the film cover 48. The overlying container bodies are shown with the film cover 48 and have a gate 30 in covering relation to the fill aperture 50 in the film cover 48. Thus, in this scenario as illustrated in FIG. 16, steam being controllably released from the underlying container body for cooking the food within the container bodies 12 or 104 is released from the steam aperture 36 or 126 within the lid 102 or the gate 30 and passes toward the underside of the overlying container body 12 or 104 and is channeled away from the underlying container body 12 or 104 around the overlying container body 12 or 104 by way of the steam channels 26. Similarly, the overlying container bodies 12 or 104 release steam through the steam aperture 126 fashioned within the gate 30 for creating a pressure cooking environment within the container body 104 whereby the food or ingredients within each of the container bodies 12 or 104 is cooked simultaneously within the microwave for producing a single meal. The present invention further contemplates that each of the container bodies 202, 204 and 206 shown in FIGS. 11A-11C may be used with the lid 102 for serving purposes, and to keep the food within each container body 202, 204 and 206 warm or for cooking within the microwave 56. The present invention also appreciates the flexibility of the container bodies 202, 204 and 206 for cooking food within the microwave 56. For example, the container body 206 shown in FIG. 11A may be sealed with a lid 102 and used to cook ingredients or food within the container body 206 by controllably releasing steam from the container body 206 through the steam aperture 126 in the lid 102. In another configuration of the container bodies 202, 204 and 206, the components of a full meal may be inserted into each individual container body and then the container bodies may be nested atop or within an underlying container body in position, in space saving fashion, within the microwave 56 for cooking each of the ingredients at the same time for creating a single meal. In another aspect of the present invention, two or 5 more container bodies 104 may be stacked on top of the other having a lid 102. Thus, each of the food items in each of the container bodies 104 is cooked by energy from the microwave and steam controllably released through the steam aperture 126 within the lid 102. During cooking, steam channels 26, such as those shown in FIG. 16, within the bottom wall 14 of each of the container bodies helps channel steam escaping from the steam aperture 126 in the lid 102 of an underlying container body.

The present invention further contemplates how each of the container bodies 202, 204 and 206 shown in FIG. 11A-11C may be used to cook an entire meal by nesting the container bodies 202, 204 and 206 within each other (as shown in FIG. 12) within the microwave 56. For example, a meat product such as hamburger may be positioned within the container body 202 shown in FIG. 11C, a vegetable such a broccoli may be positioned within a container body 204 shown in FIG. 11B, and another vegetable such as potatoes may be positioned in the container body 206 shown in FIG. 11A. The container body 202 shown in FIG. 11C may be nested within the container body 204 shown in FIG. 11B and both container bodies 202 and 204 may be, in turn, nested within the container body 206 shown in FIG. 11A. A lid 102 is positioned atop the container body 202 shown in FIG. 11C when nested within the container bodies 204 and 206 shown in FIGS. 11B and 11A. The present invention also contemplates that various foods may be sequenced and cooked simultaneously within each of the container bodies 202, 204 and 206 nested within the other and within the base container 206 (shown in FIG. 11A). Those skilled in the art can appreciate how each of the foods is separated from the other in each of the container bodies 202, 204 and 206 so that steam is transferred from the underlying container bodies to the overlying container bodies to evenly cook each of the food items in each of the container bodies 202, 204 and 206 using steam, pressure and energy from the microwave 56. Similarly, each of the container bodies 202, 204 and 206 shown in FIGS. 11A-11C may be used in a stand alone configuration.

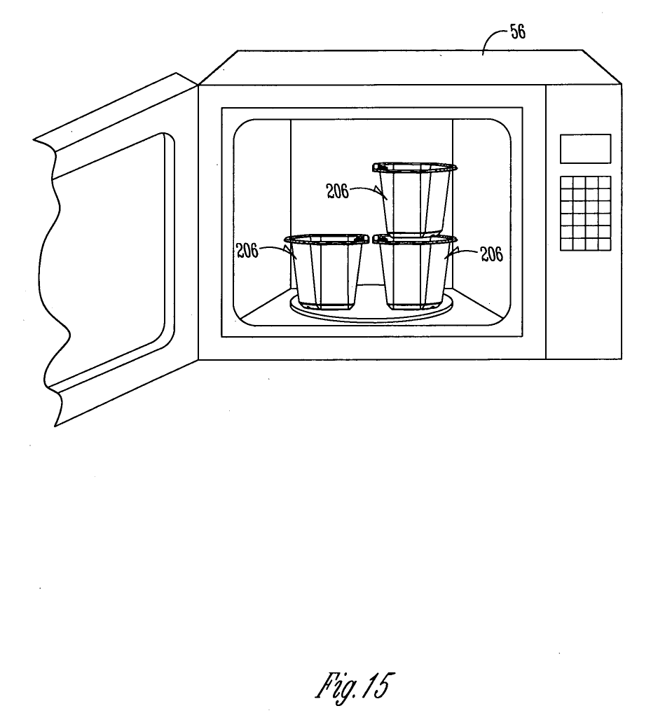

FIG. 14 illustrates another embodiment of the microwavable cooking container assembly 30. By inserting a gate 302, such as the gate 30 in FIG. 4, into the recess 304 in each of the container bodies 202, 204 and 206 shown in FIGS. 11A-11C, and fashioning a film cover 306, such as the film cover 48 shown in FIG. 1, over the top of the gate 302 attached to the top rim 210 of each of the container bodies 202, 204 and 206, the container bodies may be used in an alternative configuration in addition to those previously discussed. In this manner, food may be prepackaged then sealed by food-safe, shrinkable wrap within each of the container bodies 202, 204 and 206 for resale, as previously discussed. Thus, each of the container bodies 202, 204 and 206 could be purchased having the prepackage ingredients, taken home, have additional ingredients added to the container body 202, 204 or 206 through the fill aperture 308 in the film cover 306 for creating a complete meal using one or more of the container bodies 202, 204 and 206 having prepackaged food. Additionally, and alternatively, the container bodies 202, 204 or 206 could be sold without prepackaged food having a food-safe, shrinkable cover surrounding the container assembly which could be removed so that food and ingredients could be inserted into the container body 202, 204 and 206 through the fill aperture 308 in the film cover 306. In both instances, one or more of the container bodies 202, 204 and 206 could be inserted into the microwave oven 56 in space saving fashion, as shown in FIG. 15, to cook each of the ingredients within each of the container bodies 202, 204 and 206 by creating a pressure cooking environment within each of the container bodies 202, 204 and 206 by controllably releasing steam through the steam aperture 310 in the gate 302. In a stacked configuration, as best shown in FIG. 16, steam exiting the underlying container body 206 through the steam aperture 310 in the gate 302 is channeled away from the underlying container body 206 around the overlying container body 206 by way of steam channels 228 in the bottom wall 208 of the overlying container body 206.

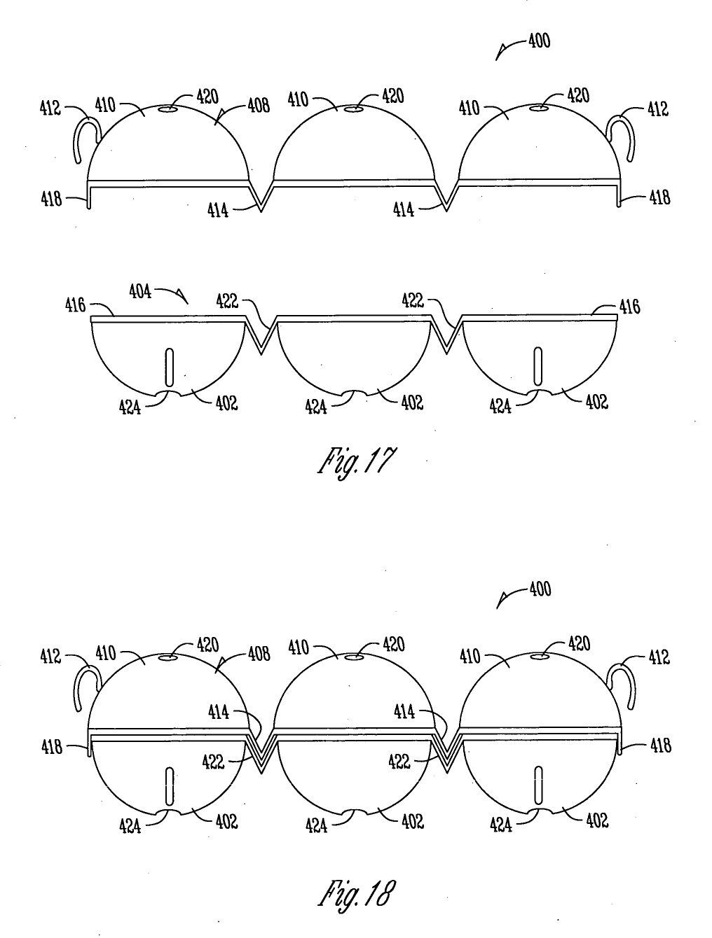

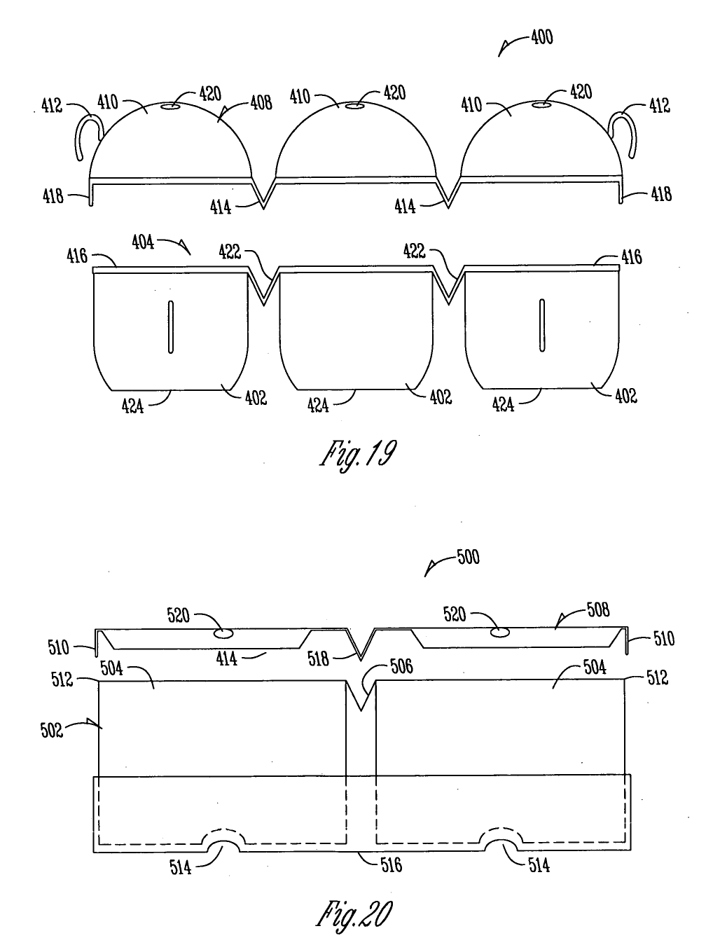

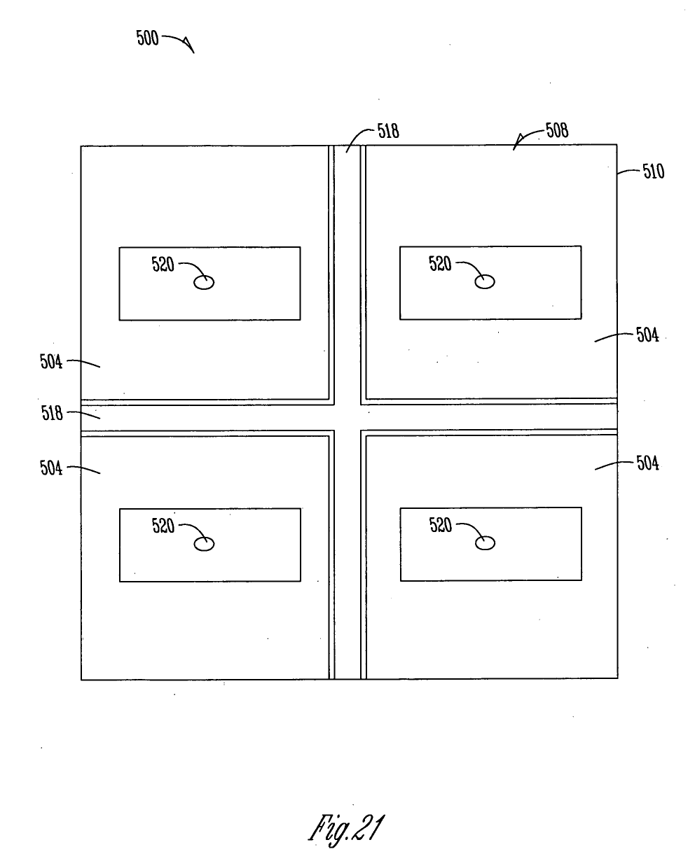

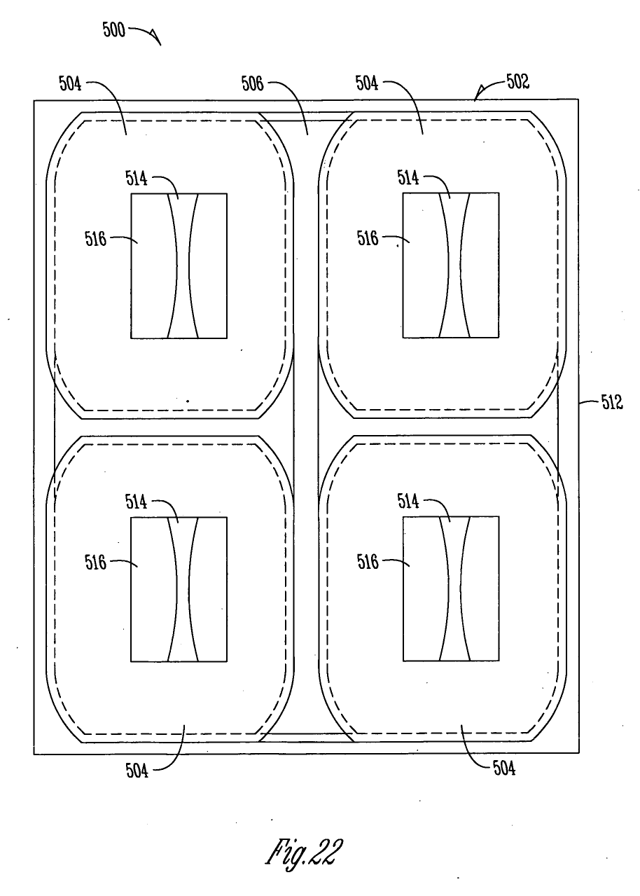

FIGS. 17-22 illustrate another embodiment of the microwavable cooking container assembly according to an exemplary embodiment of the present invention. In this embodiment, each of the cavities 402 in the tray 404 allows foods to be separated and cooked according to the individual taste and dietary needs of each person. To do this, the microwavable cooking container assembly 400 shown in FIGS. 17-19 have a base container body with one or more cavities separated from the others. The cavities 402 formed within the base container body 406 may be semi-cylindrical shaped, oval shaped, or otherwise to help facilitate separation of foods from other foods within the base container body 406 having different dietary needs and taste requirements. A similarly shaped lid 408 having one or more cavities 410 fashioned to complement the cavities 402 formed within the base container body 406 is spaced apart between a pair of handles 412. Each of the cavities 410 in the lid 408 and the base container body 406 are separated by a V-shaped rib 414. Also, positioned on the outer perimeter 416 of the lid 408 is a flange 418. Within each of the cavities 410 in the lid 408 is a steam aperture 420 for controllably releasing steam from the microwavable cooking container assembly 400. Once ingredients are positioned within each of the separate cavities 402 of the base container body 406, the lid 408 is positioned atop the base container body 406 so that the V-shaped rib 414 in the lid 408 mate with the V-channels 422 in the base container body 406. The flanges 418 on the lid 408 grip the outer perimeter 416 of the base container body 406 to thereby retain the lid 408 on top of the base container body 406. A steam channel 424 is fashioned within each of the cavities 402 of the base container body 406 to help channel steam from an underlying container body past the overlying container body when stacking the microwavable cooking container assemblies. FIGS. 20-22 show another microwavable cooking container assembly 500 according to another aspect of the present invention. In FIGS. 20-22, the base container body 502 has rectangular or square shaped cavities 504 connected by a V-channel 506. The lid 508 also has a flange 510 on its outer perimeter 512 for keeping the lid 508 attached to the base container body 502. A steam channel 514 is fashioned in the bottom wall 516 of each of the cavities 504 of the base container body 502. The lid 508 has a V-shaped rib 518 for mating with the V-channel 506 in the base container body 502. A steam aperture 520 is fashioned within each section of the lid 508 adapted to cover each of the cavities 504 in the base container body 502. By fashioning the cavities 504 separate from each other and in a single container body, foods may be cooked at the same time but yet separated from each other to meet the dietary and taste requirements of each person individually.

In the drawings and specification there has been set forth a preferred embodiment of the invention, and although specific terms are employed, these are used in a generic and descriptive sense only and not for the purposes of limitation. Changes in the form and the proportion of parts as well as in the substitution of equivalents are contemplated as circumstances may suggest or rendered expedient without departing from the spirit or scope of the invention as further defined in the following claims.

What is claimed is:

1. A microwavable cooking container assembly comprising:
a container body having a bottom wall and a top rim spaced apart by a substantially upright planar wall connected at opposite ends to a substantially upright convex wall;
a notch extending downward from the top rim toward the bottom wall parallel to the substantially upright planar wall;
a gate with a substantially planar body defined by an outer perimeter and having a steam aperture in the substantially planar body and a projection extending away from the substantially planar body for inserting within the notch;
a film cover attached to the top rim over the gate and having a fill aperture in communication with the container body; and
the gate moveable between a blocking position in covering relation to the fill aperture and a fill position for passing cooking ingredients through the fill aperture past the gate into the container body.

2. The microwavable cooking container assembly of claim 1 further comprising a recess in the substantially upright planar wall extending from the bottom wall to the top rim for nesting and stacking one container within another.

3. The microwavable cooking container assembly of claim 1 further comprising one or more channels in the bottom wall for channeling steam and suspending cooking ingredients above the bottom wall.

4. The microwavable cooking container assembly of claim 1 wherein a detent within the notch mates with a keeper notch on the projection for keeping the projection within the notch and urging the gate from the fill position to the blocking position.

5. The microwavable cooking container assembly of claim 1 wherein the gate in the blocking position prevents steam from escaping the container body through the fill aperture.

6. The microwavable cooking container assembly of claim 1 wherein steam from the container body is controllably released through the steam aperture to thereby create a pressure cooking environment for cooking ingredients within the container body.

7. The microwavable cooking container assembly of claim 1 wherein the gate further comprises a reinforcement rib running along the outer perimeter of the substantially planar body to strengthen the substantially planar body against failure and transfer resistance to movement toward the fill position from the projection into the planar body to bias the gate toward the blocking position.

8. The microwavable cooking container assembly of claim 1 wherein the container body is half-moon shaped to thereby facilitate positioning the substantially upright planar walls of two containers adjacent each other to best use space within a microwave.

9. A microwavable cooking container assembly comprising:
a container body having a bottom wall and a top rim spaced apart by a substantially upright planar wall connected at opposite ends to a substantially upright convex wall;
a notch extending downward from the top rim toward the bottom wall parallel to the substantially upright planar wall;
a ledge seat along an inside perimeter of the top rim;
a lid with a lid body defined by a planar outer perimeter for mating with the top rim, a handle for gripping formed between oppositely spaced recesses in the lid body, and a positing rib running adjacent along the outer perimeter shaped to mate with the ledge seat; and
a steam aperture in the lid body for controllably releasing stem from the container body to thereby create a pressure cooking environment for cooking ingredients within the container body.

10. The microwavable cooking container assembly of claim 9 further comprising a stacking recess extending from the bottom wall to the top rim in the substantially upright planar wall.

11. The microwavable cooking container assembly of claim 9 wherein one or more container bodies nests inside another container body and/or each other for cooking food and/or ingredients separately in each container body to meet the dietary, nutritional and taste requirements of each person individually.

12. The microwavable cooking container assembly of claim 11 further comprising one or more semi-conical recesses in the substantially upright convex wall extending from the bottom wall and terminating adjacent the top rim in a planar surface parallel with the top rim and having a steam aperture there through.

13. The microwavable cooking container assembly of claim 12 wherein the steam aperture channels steam from one or more underlying nested contain bodies into the above container body for cooking food and/or ingredients in each container body.

14. A microwavable cooking container assembly comprising:
a base container body having two or more cavities to hold food to meet the individual dietary, nutritional and taste requirements for each person;
a top container body having corresponding geometry to the base container body to individually seal each cavity from the other; and
a steam aperture in the top container corresponding with each cavity to cook the food with steam in each cavity at a rate corresponding to each food type.

15. The microwavable cooking container assembly of claim 14 wherein the base and top container bodies include one or more corresponding geometries to seal and position the top container relative to the bottom container when joined together.

16. The microwavable cooking container assembly of claim 14 wherein the base container body has a steam channel to direct steam from an underlying container when two are stacked together.

17. A method for cooking of one or more foods in a microwavable cooking container assembly within a microwave, the method comprising:
taking the microwavable cooking container assembly having a container body with a bottom wall and a top rim spaced apart by sidewalls, a gate attached to the top rim and a film cover attached to the top rim over the gate and having a fill aperture in communication with the container body;
flexing the gate open away from the film cover;
inserting ingredients through the fill aperture past the gate into the container body;
placing the container body with the microwave;
heating ingredients within the container body;
releasing steam from a steam aperture in the gate; and
controlling the rate of cooking using the steam in the container body and energy from the microwave.

18. The method of claim 17 further comprising the step of urging the gate to a closed position in covering relation over the fill aperture using reflex behavior in the gate.

19. The method of claim 17 further comprising the step of sealing one or more foods within the container body for resale.

20. The method of claim 19 further comprising the step of removing the seal for adding additional ingredients through the fill aperture to prepackaged foods within the container body.

21. The method of claim 17 further comprising the step of corrugating the bottom wall with steam channels for channeling steam from one or more underlying microwavable cooking container assemblies and suspending food above the bottom wall.

22. The method of claim 17 further comprising the step of shaping the container body in a half-moon shape for placing two containers back to back within the microwave.

23. A method for microwave cooking one or more foods in a microwavable cooking container assembly within a microwave, the method comprising:
taking the microwavable cooking container assembly having a container body with a bottom wall and a top rim spaced apart by sidewalls, and a lid with a lid body defined by a planar outer perimeter and having a handle and a steam aperture;
inserting ingredients into the container body;
sealing the lid to the container body by mating the planar outer perimeter on the top rim;
placing the container body with the microwave;
heating ingredients within the container body;
releasing steam from the container body through the steam aperture in the lid; and
controlling the rate of cooking using steam in the container body and energy from the microwave to thereby create a pressure cooking environment for cooking ingredients within the container body.

24. The method of claim 23 further comprising the step of securing the lid against movement relative to the container body by mating a sealing rib running adjacent along the planar outer perimeter within a ledge seat along the top rim.

25. The method of claim 23 further comprising the step of placing one or more semi-conical recesses in the sidewall extending from the bottom wall and terminating adjacent the top rim in a planar surface parallel with the top rim and having a steam aperture there through.

26. The method of claim 25 further comprising the step of nesting one or more container bodies inside another container body and/or each other for cooking ingredients separately in each container to provide sequenced and simultaneous cooking of the ingredients or separated foods in each nested container.

27. The method of claim 26 further comprising the step of transferring steam from one or more underlying container bodies through the steam aperture in the container body to one or more overlying container bodies within the container body for cooking ingredients in each container body.

28. The method of claim 27 further comprising the step of channeling steam from an underlying container body upward toward the steam aperture in the overlying container body with one or more steam channels in the bottom wall.

29. The method of claim 23 further comprising the step of recessing the sidewall of the container body for stacking and nesting one inside another.

30. The method of claim 23 further comprising the step of forming the handle for gripping between oppositely spaced recesses in the lid body.

31. A method for sequenced microwave cooking of one or more foods separate from each other at the same time in the same container, the method comprising:
providing two or more microwavable containers, wherein a second container nests inside a base container and the two are covered by a lid with a steam aperture to separately cook two or more foods having separate cooking times;
filling the base container with a first food having a first cooking time;
filling the second container with a second food having a second cooking time;
cooking the first food in the base container with the lid in the microwave;
nesting the second container in the base container when an elapsed time on the microwave equals the second cooking time; and
lidding the second container to cover the base container to sequentially cook the first and second foods with steam.

32. The method of claim 31 further comprising the step of adding liquid to the base container to create steam to assist in cooking the first food in the base and the second food nested above the first food in the second container.

33. A system for microwave cooking one or more foods separate from each other at the same time in the same container, the system comprising:
one or more microwavable containers nested inside each other within a base container;
a lid having a steam aperture and a handle for gripping, the lid adapted to sealingly engage and cover each of the microwavable containers and the base container whether nested together or used separately;
a sleeve having an inside cover and an outside cover houses and keeps the microwavable containers together for resale and storage; and
one or more recipe software printed on the inside cover of the sleeve for describing operation of the system.

34. The system of claim 33 wherein the outside cover has advertising indicia to promote and sell the system.

35. The system of claim 33 wherein a user follows the recipe software to cook food separate from each other or at the same time in one or more of the microwavable containers within the base container according to the respective wattage for the microwave and cook timer for the separate food so that each food is fully cooked at the same time thereby providing a complete meal.
